(19) United States
(12) Patent Application Publication
(10) Pub. No.: US 2007/0199579 A1
(43) Pub. Date: Aug. 30, 2007

(54) Substrate treatment method, substrate treatment apparatus, and semiconductor device manufacturing method

(76) Inventors: Kei Hayasaki, Kamakura-shi (JP); Eishi Shiobara, Yokohama-shi (JP); Shinichi Ito, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/706,992

(22) Filed: Feb. 16, 2007

(30) Foreign Application Priority Data
Feb. 17, 2006 (JP) 2006-040836

(51) Int. Cl. C23G 1/00; B08B 7/04; B08B 3/00; B08B 7/00

(52) U.S. Cl. 134/2; 134/33; 134/26; 134/94.1; 134/149; 134/137; 134/18; 134/56 R

(57) ABSTRACT

According to an aspect of the invention, there is provided a substrate treatment method including performing a treatment including intermittently supplying a cleaning fluid to a central area of a treatment substrate while continuously rotating the substrate, and continuously supplying a cleaning fluid to a peripheral area of the substrate, thereby treating the substrate so that a liquid film on the substrate monotonously increases from the central area to the peripheral area along with the rotation of the substrate and so that the central area substantially dries.

### CROSS-REFERENCE TO RELATED APPLICATIONS

This application is based upon and claims the benefit of priority from prior Japanese Patent Application No. 2006-040836, filed Feb. 17, 2006, the entire contents of which are incorporated herein by reference.

### BACKGROUND OF THE INVENTION

1. Field of the Invention

The present invention relates to a substrate treatment technique for cleaning a substrate surface. More particularly, the present invention relates to a substrate treatment method, a substrate treatment apparatus and a semiconductor device manufacturing method for use in a treatment of washing off a photosensitive resist in the manufacture of a semiconductor device, ULSI, electronic circuit component, liquid crystal display element, etc.

2. Description of the Related Art

In the manufacture of a semiconductor device, the production of fatal defects due to insufficient cleaning has been a large problem in a process of washing off a photosensitive resist (e.g., a rinsing process in a development process or a cleaning process in a liquid immersion process) along with increasing diameters of substrates. In a conventional method of cleaning and drying a substrate by supplying a cleaning fluid from a straight nozzle while rotating the substrate, the substrate dries faster in its outer peripheral part than in its central part due to the influence of turbulence in the outer periphery of the substrate resulting from the increased diameter, so that this method has a problem that substances washed off and removed in the central part remain on the outer peripheral part of the substrate.

As a method of solving this problem, there is a method comprising supplying the cleaning fluid in the center while rotating the substrate at an initial stage of the cleaning process, and scanning the substrate with a cleaning fluid supply nozzle from the center to the outer periphery of the substrate (e.g., refer to Jpn. Pat. Appln. KOKAI Publication No. 2002-57088). This method prevents the outer peripheral part of the substrate from drying, and reduces defects in the outer peripheral part of the substrate. However, this method has a problem of insufficient removal of defects in the center of the substrate.

Thus, there has heretofore been a problem that the substances washed off and removed in the central part of the substrate remain on the outer peripheral part of the substrate in the method of cleaning and drying the substrate by supplying the cleaning fluid from the nozzle while rotating the substrate to wash off the photosensitive resist. Moreover, in the cleaning method in which the substrate is scanned with the cleaning fluid supply nozzle from the center to the outer periphery of the substrate, defects in the outer peripheral part of the substrate are reduced, but there has been the problem of insufficient removal of defects in the center of the substrate.

### BRIEF SUMMARY OF THE INVENTION

According to an aspect of the invention, there is provided a substrate treatment method comprising performing a treatment including intermittently supplying a cleaning fluid to a central area of a treatment substrate while continuously rotating the substrate, and continuously supplying a cleaning fluid to a peripheral area of the substrate, thereby treating the substrate so that a liquid film on the substrate monotonously increases from the central area to the peripheral area along with the rotation of the substrate and so that the central area substantially dries.

According to another aspect of the invention, there is provided a substrate treatment method comprising: supplying a predetermined amount of a cleaning fluid from a first nozzle to a central area of a treatment substrate while rotating the substrate, and continuously supplying a cleaning fluid from a second nozzle to a peripheral area of the substrate simultaneously with or behind the start of the supply from the first nozzle, thereby treating the substrate so that a liquid film on the substrate monotonously increases from the central area to the peripheral area and so that the central area substantially dries; supplying a predetermined amount of the cleaning fluid from the first nozzle to the central area of the substrate while continuing the rotation of the substrate and the supply of the cleaning fluid by the second nozzle, thereby treating the substrate so that the liquid film on the substrate monotonously increases from the central area to the peripheral area and so that the central area substantially dries; and stopping the supply of the cleaning fluid by the second nozzle so that the peripheral area of the substrate dries.

According to another aspect of the invention, there is provided a substrate treatment apparatus comprising: a stage on which a treatment substrate is mounted and which rotates the substrate; a first nozzle which supplies a predetermined amount of a cleaning fluid to a central area of the substrate and then stops the supply; a second nozzle which continuously supplies a cleaning fluid to a peripheral area of the substrate; a surface monitoring mechanism which monitors the state of the cleaning fluid on the surface of the substrate after the predetermined amount of the cleaning fluid is supplied from the first nozzle and which detects interference fringes; and a control section which again supplies the cleaning fluid by the first nozzle and stops the supply after a time when the interference fringes are detected in the central area of the substrate by the surface monitoring mechanism.

According to another aspect of the invention, there is provided a substrate treatment apparatus comprising: a stage on which a treatment substrate is mounted and which rotates the substrate; a control section which supplies a predetermined amount of a cleaning fluid from a nozzle to a central area of the substrate and then stops the supply; and a monitoring mechanism which optically monitors the state of the cleaning fluid on the surface of the substrate after the supply of the cleaning fluid and the stopping of the supply and which detects a time when the interference fringes are produced in the central area while a peripheral area of the substrate is not dry, wherein the control section repeats the supply of the cleaning fluid by the nozzle and the stopping of the supply in accordance with the result of the detection by the monitoring mechanism.

According to another aspect of the invention, there is provided a semiconductor device manufacturing method comprising: performing a treatment including intermittently supplying a cleaning fluid to a central area of a treatment substrate while continuously rotating the substrate, and continuously supplying a cleaning fluid to a peripheral area of the substrate, thereby treating the substrate so that a liquid film on the substrate monotonously increases from the central area to the peripheral area along with the rotation of the substrate and so that the central area substantially dries; and using the substrate to manufacture a semiconductor device.

According to another aspect of the invention, there is provided a semiconductor device manufacturing method comprising: supplying a predetermined amount of a cleaning fluid from a first nozzle to a central area of a treatment substrate while rotating the substrate, and continuously supplying a cleaning fluid from a second nozzle to a peripheral area of the substrate simultaneously with or behind the start of the supply from the first nozzle, thereby treating the substrate so that a liquid film on the substrate monotonously increases from the central area to the peripheral area and so that the central area substantially dries; supplying a predetermined amount of the cleaning fluid from the first nozzle to the central area of the substrate while continuing the rotation of the substrate and the supply of the cleaning fluid by the second nozzle, thereby treating the substrate so that the liquid film on the substrate monotonously increases from the central area to the peripheral area and so that the central area substantially dries; stopping the supply of the cleaning fluid by the second nozzle so that the peripheral area of the substrate dries; and using the substrate to manufacture a semiconductor device.

### BRIEF DESCRIPTION OF THE SEVERAL VIEWS OF THE DRAWING

FIG. 1 is a schematic configuration side view showing a substrate treatment apparatus according to an embodiment of the present invention;

FIGS. 2A, 2B and 2C are views showing a sequence of a development treatment according to the embodiment of the present invention;

FIGS. 3A, 3B, 3C and 3D are views showing a sequence of cleaning and drying by a conventional method, according to the embodiment of the present invention;

FIGS. 4A, 4B, 4C and 4D are views showing an example of carrying out the sequence of cleaning and drying by the conventional method in the apparatus shown in FIG. 1, according to the embodiment of the present invention;

FIG. 5 is a chart showing results of the monitoring of the intensity of reflected light by monitoring means to see a state produced by a conventional rinsing and drying method, according to the embodiment of the present invention;

FIGS. 6A, 6B, 6C, 6D, 6E and 6F are views showing a sequence of cleaning and drying according to the embodiment of the present invention;

FIGS. 7A and 7B are views showing a state of cleaning when interference fringes are produced, according to the embodiment of the present invention; and

FIGS. 8A and 8B are views showing a relation between defects and a liquid film, according to the embodiment of the present invention.

### DETAILED DESCRIPTION OF THE INVENTION

An embodiment will hereinafter be described with reference to the drawings. In the following embodiment, an example will be described in which the present invention is applied to rinsing and drying treatments in a development process of a photosensitive resin film, but it should be understood that the present invention is not limited thereto.

FIG. 1 is a schematic configuration side view showing a substrate treatment apparatus used in one embodiment of the present invention. The operation of the substrate treatment apparatus is controlled by a control section 100. A treatment substrate (semiconductor substrate) 10 such as an Si wafer is mounted on a specimen stage 21, and the specimen stage 21 can be rotated by a rotation mechanism 22. Above the specimen stage 21, there are disposed a developing solution supply nozzle 30 for supplying a developing solution to the surface of the substrate 10, and cleaning fluid supply nozzles 41 and 42 for supplying a cleaning fluid. The developing solution supply nozzle 30 has a wide slit having a length equal to the diameter of the substrate 10, and the cleaning fluid supply nozzles 41 and 42 have small round holes. These nozzles 30, 41 and 42 are movable along the direction of the substrate surface under the control of the control section 100. Around the specimen stage 21, there is provided a cup 23 for preventing a chemical from scattering around.

Furthermore, above the specimen stage 21, there are provided surface monitoring mechanisms 51 and 52 for applying single-wavelength light onto the substrate 10 and monitoring the intensity of light reflected from the substrate 10. These monitoring mechanisms 51 and 52 have only to be able to monitor a substrate surface area and a peripheral area, and are attached to, for example, the nozzles 41 and 42, respectively.

Next, a cleaning treatment according to the present embodiment will be described in comparison with a cleaning treatment according to a conventional method.

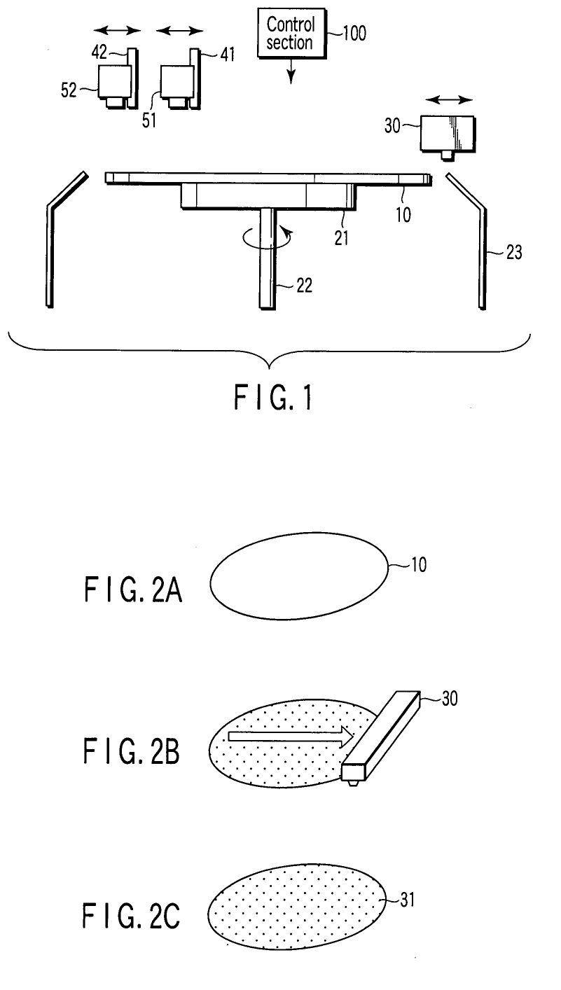

First, an antireflection film is formed on and a chemically amplified resist is applied onto the treatment substrate (300-mm wafer), and then a desired pattern is subjected to reduced projection exposure via an exposure reticle using an ArF excimer laser. After the exposed substrate is thermally treated, a development treatment is carried out in a sequence in FIGS. 2A to 2C. That is, the substrate 10 shown in FIG. 2A is scanned with the developing solution supply nozzle 30 in one direction while the developing solution is being discharged to the substrate 10 from the nozzle 30 as shown in FIG. 2B, thereby forming a developing solution film 31 on the substrate 10 as shown in FIG. 2C. Then, stationary development is carried out for a predetermined time.

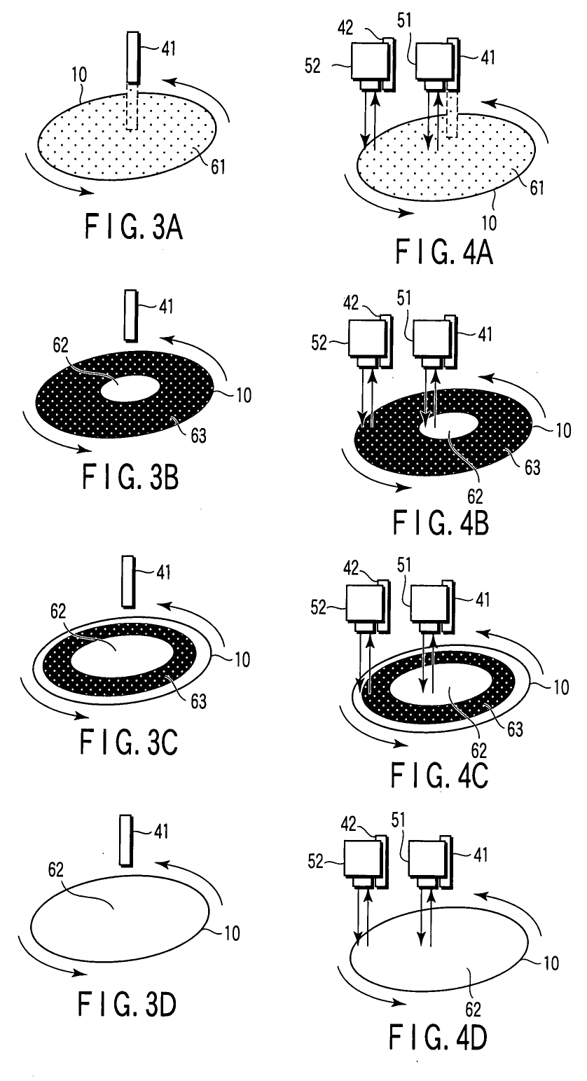

Subsequently, a cleaning treatment with pure water and a drying treatment are carried out, and a sequence shown in FIGS. 3A to 3D is employed in the case of the conventional method. First, stationary development is carried out for a predetermined time, and then pure water 61 is supplied from the cleaning fluid supply nozzle 41 while the treatment substrate 10 is being rotated, as shown in FIG. 3A. After a predetermined time, the supply of the pure water 61 is stopped, and the treatment substrate 10 is rotated to shake off the pure water 61 and dry the treatment substrate 10. At this point, a dry area 62 is first formed in a central part as shown in FIG. 3B, around which an interference fringe area 63 is formed. Then, as shown in FIG. 3C, the dry area 62 expands outward, and the dry area 62 is also formed in a peripheral area of the substrate 10. Then, the entire area finally becomes the dry area 62, as shown in FIG. 3D.

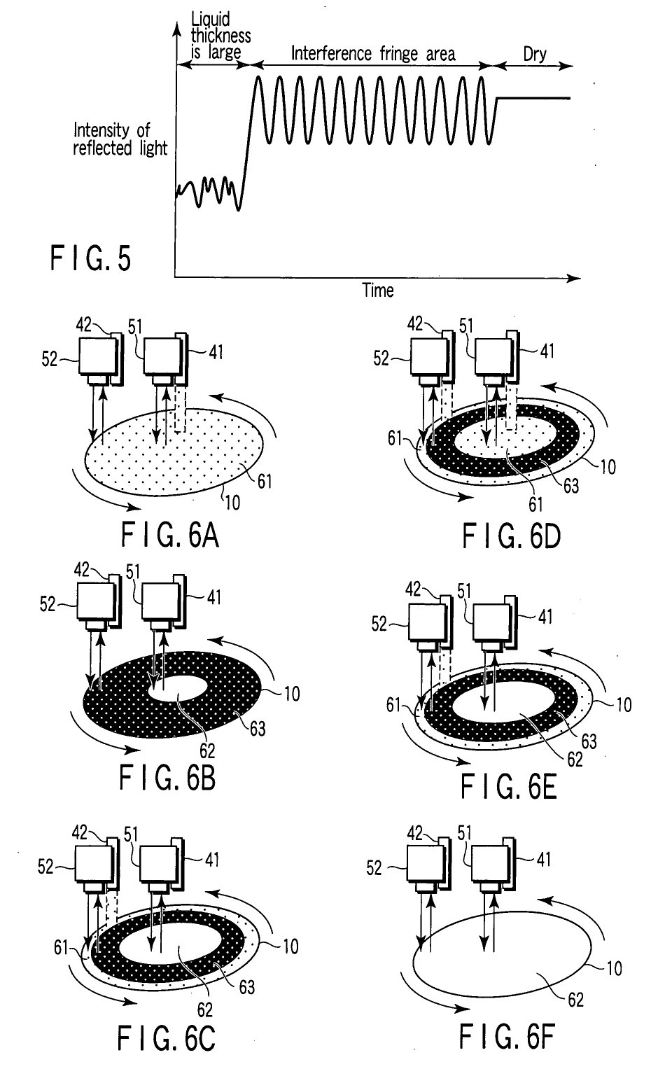

Here, in FIG. 5, there are shown results of the monitoring of the intensity of the reflected light by monitoring means as shown in FIGS. 4A to 4D using the apparatus shown in FIG. 1 to see a state produced by a conventional rinsing and drying method. FIGS. 4A to 4D correspond to FIGS. 3A to 3D, respectively. As shown in FIG. 5, random reflected light is obtained when the thickness of the liquid is large (for several seconds after the supply of the liquid is stopped). Then, the intensity of the reflected light periodically changes while interference fringes are being observed (about 10 to 15 seconds). When the substrate is completely dry, there is no longer a change in the intensity.

A method of the present embodiment is shown in FIGS. 6A to 6F. Stationary development is carried out for a predetermined time, and then the cleaning fluid (pure water) 61 is supplied from the cleaning fluid supply nozzle 41 to the center area of the substrate 10 while the treatment substrate 10 is being continuously rotated, as shown in FIG. 6A. After a predetermined time, the supply of the pure water 61 is stopped, and the treatment substrate 10 is dried while being rotated. In this manner, the substrate 10 is treated so that a liquid film on the substrate monotonously increases from the central area to the peripheral area along with the rotation of the substrate and so that the central area substantially dries. Thus, as shown in FIG. 6B, the dry area 62 is formed in the central part, around which the interference fringe area 63 is formed. In the meantime, the intensity of the reflected light is monitored by the two monitoring mechanisms 51 and 52. Then, while the outer peripheral part of the substrate 10 has the interference fringe area 63, the cleaning fluid (pure water) is supplied to the outer peripheral part of the substrate from the cleaning fluid supply nozzle 42, as shown in FIG. 6C. This can prevent the substrate 10 from drying from its outer peripheral part. It is to be noted that the cleaning fluid is continuously supplied from the nozzle 42. In addition, the supply of a cleaning fluid from the cleaning fluid supply nozzle 42 may be performed simultaneously with or behind the start of the supply from the cleaning fluid supply nozzle 41. The supply of the cleaning fluid may be performed while the position to supply the cleaning fluid from the cleaning fluid supply nozzle 42 to the peripheral area of the substrate is moved by the control section 100 from a specific position (first position) in the peripheral area of the substrate 10 to a second position (a position within 5 mm from the outer periphery of the substrate) which is closer to the outer periphery (edge) of the substrate 10 than the first position.

Next, when the central part of the substrate is dry, i.e., at a time after interference fringes in the central area of the substrate have disappeared, the cleaning fluid (pure water) 61 is again supplied from the cleaning fluid supply nozzle 41, as shown in FIG. 6D. That is, the cleaning fluid from the cleaning fluid supply nozzles 41 is supplied to the central area of the substrate 10 while continuing the rotation of the substrate 10 and the supply of the cleaning fluid by the cleaning fluid supply nozzle 42. After a predetermined time, the supply from the cleaning fluid supply nozzle 41 is stopped. Then, the supply of the cleaning fluid 61 from the cleaning fluid supply nozzle 42 is stopped when the central part of the substrate is substantially dry as shown in FIG. 6E, and the entire surface of the substrate 10 including the peripheral area completely dries as shown in FIG. 6F. At this point, the interference fringe area 63 further expands outward to be replaced with the dry area 62. It should be noted that the supplying the cleaning fluid from the cleaning fluid supply nozzle 42 and the supplying the cleaning fluid from the cleaning fluid supply nozzle 41 described above may be repeated a plurality of times. In these sequences, the drying of the substrate 10 and the state of the interference fringes after a predetermined amount of the cleaning fluid is supplied are detected by the monitoring mechanisms 51 and 52.

When defects are measured after the treatment of the treatment substrate 10 in the sequences in FIGS. 3A to 3D and FIGS. 6A to 6F, eighty thousand defects or more are found in the sequence in FIGS. 3A to 3D which seem to be the unmelted resist. The defects are distributed all over the surface, and a large number of defects are found especially in the dry area in the outer peripheral part of the substrate shown in FIG. 3C. In contrast, in the sequence in FIGS. 6A to 6F, defects in the outer peripheral part and the central part can be removed, and the number of defects is about one hundred.

Next, a mechanism of defect reduction according to the present embodiment will be described.

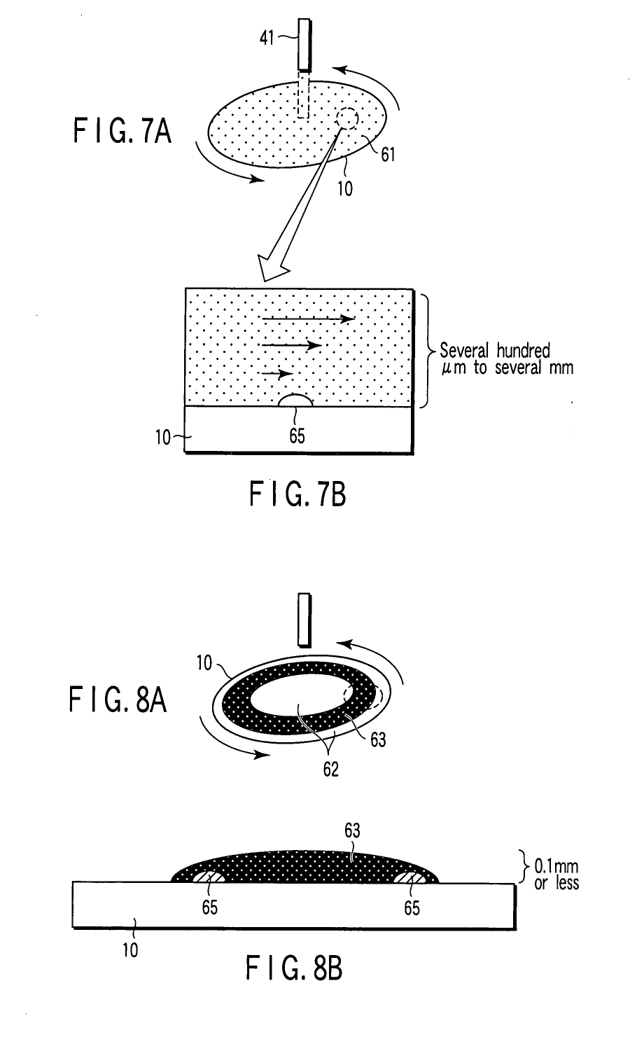

In the method which rotates the treatment substrate 10 while supplying the pure water 61 onto the substrate 10, the thickness of the liquid is several hundred μm to several mm as shown in FIGS. 7A and 7B, so that the force of the liquid flow is not adequately transmitted to a defect 65 on the substrate 10, resulting in a low removing capability. It is to be noted that FIG. 7A is a perspective view showing the entire configuration, and FIG. 7B is a sectional view showing a part enclosed by a dotted line in FIG. 7A in an enlarged form.

In contrast, when water is removed in the drying process, the thickness of the liquid film is 0.1 mm or less as shown in FIGS. 8A and 8B, and 10 nm or less at a stage where the interference fringes are found, so that sufficiently great force acts on the defect 65. If the dry area is followed by the liquid film area when radially viewed from the center of the substrate 10, the force working on the defect 65 is great, and there is the liquid on an outer side, so that the defect 65 is removed (the left defect 65 in FIG. 8B). In contrast, if the liquid film area is followed by the dry area, the force acting on the defect 65 is present, but there is no liquid on the outer side, such that the defect 65 is not removed.

In the sequence in FIGS. 3A to 3D, phenomena as shown in FIGS. 7A and 7B and in FIGS. 8A and 8B occur, so that the defects 65 are removed to some degree in the state of FIGS. 7A and 7B, and the defects 65 are removed where the dry area is followed by the liquid film area in the state of FIGS. 8A and 8B while the defects 65 remain where the liquid film is followed by the dry area, and it is therefore considered that the number of defects 65 is larger especially in the outer peripheral part. In contrast, in the sequence in FIGS. 6A to 6F, the pure water 61 is supplied to the outside of the interference fringe area 63 to further expand the interference fringe area 63 outward, such that the entire area can finally be the dry area 62. Therefore, the strong force in the area where the dry area is followed by the liquid film area as shown in FIGS. 8A and 8B can act on the defects 65 (the right and left defects 65 in FIG. 8B) a plurality of times, so that the number of defects can be drastically reduced. Moreover, in the present embodiment, the drying is monitored, so that the state of the interference fringes most effective in cleaning can be detected, and an accurate treatment can be achieved.

A circuit pattern is formed on the semiconductor substrate treated as described above to manufacture a semiconductor device.

Thus, according to the present embodiment, the cleaning fluid is continuously supplied to the peripheral area of the treatment substrate 10 by the nozzle 42 together with the intermittent supply of the cleaning fluid to the central area of the substrate 10 by the nozzle 41, thereby making it possible to suppress the production of defects in the outer peripheral part of the substrate due to the faster drying of the substrate in its outer peripheral part than in its central part. Moreover, the supply of the cleaning fluid to the central area of the substrate 10 is repeated while the supply of the cleaning fluid to the peripheral part of the substrate 10 is maintained, such that the production of defects in the outer peripheral part of the substrate is suppressed, and at the same time, the defects in the central part of the substrate can be reduced. Therefore, the defects in the outer peripheral part of the substrate can be reduced, and the defects in the central part of the substrate can also be reduced, so that the washing-off, etc., of the resist after development can be effectively achieved.

It is to be noted that the present invention is not limited to the embodiment described above. The reflected light is monitored during the cleaning and drying treatments to decide the timing of the discharge of the cleaning fluid for each treatment in the embodiment, but the state of the treatment may be monitored in advance to decide the timing, and the substrate may then be treated under the same condition. Further, the example has been described in the embodiment in which the present invention is applied to the treatment of washing off the photosensitive resist after development, but the present invention is not limited to the removal of the resist or the like, and can also be applied to the general cleaning of the substrate surface.

Furthermore, the example has been shown in the embodiment in which the cleaning fluid is intermittently supplied to the vicinity of the center of the substrate while the cleaning fluid is being continuously supplied to the outer periphery of the substrate to drastically reduce the number of defects. However, when the drying in the outer periphery of the substrate can be prevented without the continuous supply of the cleaning fluid to the periphery of the substrate, similar effects can be obtained only by the intermittent supply of the cleaning fluid to the vicinity of the center of the substrate. As another method, it is also possible to employ a method which intermittently supplies the cleaning fluid to the vicinity of the center while adjusting the flow volume of the cleaning fluid and the number of rotations to prevent the drying in the outer periphery of the substrate.

Still further, while the force acting on the defects in the state having the liquid film is utilized to remove the defects in the embodiment of the present invention, the substrate in the dry state can be observed to find whether it has interference fringes, such that it is possible to judge whether the state having the liquid film is produced. It has been ascertained by experiment that the interference fringes are found and the force acting on the defects is great when the thickness of the liquid becomes 10 nm or less.

Further yet, it is also possible to use a liquid (water) containing an interfacial active agent as the cleaning fluid intermittently supplied in the center of the substrate. The process of rinsing with the liquid containing the interfacial active agent is generally conducted to prevent the collapse or release of micropatterns. The interfacial active agent is used to reduce surface tension when water is finally eliminated from between the patterns. The liquid containing the interfacial active agent is supplied in the center in the situation in which the interference fringes are found all over the substrate (situation in which no place is completely dry), such that it is possible to more efficiently replace water with the liquid containing the activator and to remove the defects in the state having the liquid film. This can reduce the amount of the liquid containing the activator used and reduce the defects.

According to the embodiment of the present invention, the continuous supply of the cleaning fluid to the peripheral area of the substrate is carried out together with the intermittent supply of the cleaning fluid to the central area of the substrate, so that it is possible to suppress the production of defects in the outer peripheral part of the substrate due to the faster drying of the substrate in its outer peripheral part than in its central part. Moreover, the supply of the cleaning fluid to the central area of the substrate is repeated while the supply of the cleaning fluid to the peripheral part of the substrate is maintained, such that the production of defects in the outer peripheral part of the substrate is suppressed, and at the same time, the defects in the central part of the substrate can be reduced. Therefore, the defects in the outer peripheral part of the substrate can be reduced, and the defects in the central part of the substrate can also be reduced, so that the washing-off, etc., of the resist after development can be effectively achieved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A substrate treatment method comprising performing a treatment including intermittently supplying a cleaning fluid to a central area of a treatment substrate while continuously rotating the substrate, and continuously supplying a cleaning fluid to a peripheral area of the substrate, thereby treating the substrate so that a liquid film on the substrate monotonously increases from the central area to the peripheral area along with the rotation of the substrate and so that the central area substantially dries.

2. The substrate treatment method according to claim 1, wherein the treatment is repeated a plurality of times.

3. A substrate treatment method comprising:
supplying a predetermined amount of a cleaning fluid from a first nozzle to a central area of a treatment substrate while rotating the substrate, and continuously supplying a cleaning fluid from a second nozzle to a peripheral area of the substrate simultaneously with or behind the start of the supply from the first nozzle, thereby treating the substrate so that a liquid film on the substrate monotonously increases from the central area to the peripheral area and so that the central area substantially dries;
supplying a predetermined amount of the cleaning fluid from the first nozzle to the central area of the substrate while continuing the rotation of the substrate and the supply of the cleaning fluid by the second nozzle, thereby treating the substrate so that the liquid film on the substrate monotonously increases from the central area to the peripheral area and so that the central area substantially dries; and
stopping the supply of the cleaning fluid by the second nozzle so that the peripheral area of the substrate dries.

4. The substrate treatment method according to claim 3, comprising repeating the treatment a plurality of times, the treatment including supplying the predetermined amount of the cleaning fluid from the first nozzle to the central area of the substrate while continuing the rotation of the substrate and the supply of the cleaning fluid by the second nozzle, thereby treating the substrate so that the liquid film on the substrate monotonously increases from the central area to the peripheral area and so that the central area substantially dries.

5. The substrate treatment method according to claim 3, wherein a time is set for the treatment including supplying the predetermined amount of the cleaning fluid from the first nozzle to the central area of the substrate while continuing the rotation of the substrate and the supply of the cleaning fluid by the second nozzle, thereby treating the substrate so that the liquid film on the substrate monotonously increases from the central area to the peripheral area and so that the central area substantially dries, the time being a time after interference fringes in the central area of the substrate have disappeared.

6. The substrate treatment method according to claim 3, wherein the position to supply the cleaning fluid to the peripheral area of the substrate is moved from a first position in the peripheral area of the substrate to a second position which is closer to an outer periphery of the substrate than the first position.

7. The substrate treatment method according to claim 6, wherein the second position is a position within 5 mm from the outer periphery of the substrate.

8. The substrate treatment method according to claim 3, wherein pure water is used as the cleaning fluid.

9. The substrate treatment method according to claim 3, wherein water containing an interfacial active agent is used as the cleaning fluid.

10. A substrate treatment apparatus comprising:
a stage on which a treatment substrate is mounted and which rotates the substrate;
a first nozzle which supplies a predetermined amount of a cleaning fluid to a central area of the substrate and then stops the supply;
a second nozzle which continuously supplies a cleaning fluid to a peripheral area of the substrate;
a surface monitoring mechanism which monitors the state of the cleaning fluid on the surface of the substrate after the predetermined amount of the cleaning fluid is supplied from the first nozzle and which detects interference fringes; and
a control section which again supplies the cleaning fluid by the first nozzle and stops the supply after a time when the interference fringes are detected in the central area of the substrate by the surface monitoring mechanism.

11. A substrate treatment apparatus comprising:
a stage on which a treatment substrate is mounted and which rotates the substrate;
a control section which supplies a predetermined amount of a cleaning fluid from a nozzle to a central area of the substrate and then stops the supply; and
a monitoring mechanism which optically monitors the state of the cleaning fluid on the surface of the substrate after the supply of the cleaning fluid and the stopping of the supply and which detects a time when the interference fringes are produced in the central area while a peripheral area of the substrate is not dry,
wherein the control section repeats the supply of the cleaning fluid by the nozzle and the stopping of the supply in accordance with the result of the detection by the monitoring mechanism.

12. A semiconductor device manufacturing method comprising: performing a treatment including intermittently supplying a cleaning fluid to a central area of a treatment substrate while continuously rotating the substrate, and continuously supplying a cleaning fluid to a peripheral area of the substrate, thereby treating the substrate so that a liquid film on the substrate monotonously increases from the central area to the peripheral area along with the rotation of the substrate and so that the central area substantially dries; and using the substrate to manufacture a semiconductor device.

13. The substrate treatment method according to claim 12, wherein the treatment is repeated a plurality of times.

14. A semiconductor device manufacturing method comprising:
supplying a predetermined amount of a cleaning fluid from a first nozzle to a central area of a treatment substrate while rotating the substrate, and continuously supplying a cleaning fluid from a second nozzle to a peripheral area of the substrate simultaneously with or behind the start of the supply from the first nozzle, thereby treating the substrate so that a liquid film on the substrate monotonously increases from the central area to the peripheral area and so that the central area substantially dries;
supplying a predetermined amount of the cleaning fluid from the first nozzle to the central area of the substrate while continuing the rotation of the substrate and the supply of the cleaning fluid by the second nozzle, thereby treating the substrate so that the liquid film on the substrate monotonously increases from the central area to the peripheral area and so that the central area substantially dries;
stopping the supply of the cleaning fluid by the second nozzle so that the peripheral area of the substrate dries; and
using the substrate to manufacture a semiconductor device.
